(19) United States
(12) Patent Application Publication
(10) Pub. No.: US 2022/0062090 A1
(43) Pub. Date: Mar. 3, 2022

(54) Back Massage Vest

(71) Applicant: Jamel L. Chisolm, Stone Mountain, GA (US)

(72) Inventor: Jamel L. Chisolm, Stone Mountain, GA (US)

(21) Appl. No.: 17/410,838

(22) Filed: Aug. 24, 2021

Related U.S. Application Data
(60) Provisional application No. 63/071,127, filed on Aug. 27, 2020.

(51) Int. Cl. A61H 7/00; A61H 23/02

(52) U.S. Cl. CPC A61H 7/004; A61H 23/02; A61H 2201/5097; A61H 2205/081; A61H 2201/1669; A61H 2201/165

(57) ABSTRACT

The back massaging device is intended to provide users with a vest that includes massaging units inbuilt within the vest. More specifically, it is an aim of the device to provide an inbuilt massaging unit with massaging arms that can travel from the shoulders to the lower back of the user. To accomplish this, the device includes two massaging units that can traverse J-shaped tracks inbuilt within the vest. In other words, the back massaging vest allows for a portable massaging device for users on the go or want to do other activities while having the comfort of a massage. The massaging arms in particular traverse a track that allow full coverage of the user's back. Further, the massaging device may be wirelessly controlled with a remote control or a wireless communication device.

The current application claims a priority to the U.S. Provisional Patent application Ser. No. 63/071,127 filed on Aug. 27, 2020.

### FIELD OF THE INVENTION

The present invention generally relates to a vest. More specifically, the present invention relates to a massaging vest having articulating arms that massage the back of a user.

### BACKGROUND OF THE INVENTION

Massaging devices come in a variety of forms from chairs and pads to vests and foot massagers. Many of these devices aim to soothe a user's muscles by applying pressure, usually in circular or kneading motions, to the muscles. This may be done by rotating spherical arms about a central axis such that the spherical arms massage a particular area of the user. Because of this construction, many back-massaging devices are not able to cover the lower back to the shoulders of the user.

An objective of the present design is to provide the user with a vest that comprises massaging units inbuilt within the vest. More specifically, it is an aim of the present invention to provide a massaging device with massaging arms that travel from the shoulders to the lower back of the user. The vest allows for a portable massaging device for users on the go or want to do other activities while having the comfort of a massage. The massaging arms in particular traverse a track that allow full coverage of the user's back. Further, the massaging device may be wirelessly controlled with a remote control or a wireless communication device.

### BRIEF DESCRIPTION OF THE DRAWINGS

FIG. 1 is a block diagram of the present invention showing arrangements of components of the present invention, wherein dashed flow lines indicate components being communicably coupled.

FIG. 2 is a block diagram of the present invention, wherein thinner flowlines represent electrical connections between components, thicker flowlines represent electronic connections between components, and dashed flow lines indicate the components being communicably coupled.

FIG. 3 is a top-rear-left perspective view of the present invention.

FIG. 4 is a rear view of the present invention.

FIG. 5 is a rear view of the present invention, wherein possible linear motion positions of the massaging units during operation is depicted through broken lines.

### DETAIL DESCRIPTIONS OF THE INVENTION

All illustrations of the drawings are for the purpose of describing selected versions of the present invention and are not intended to limit the scope of the present invention.

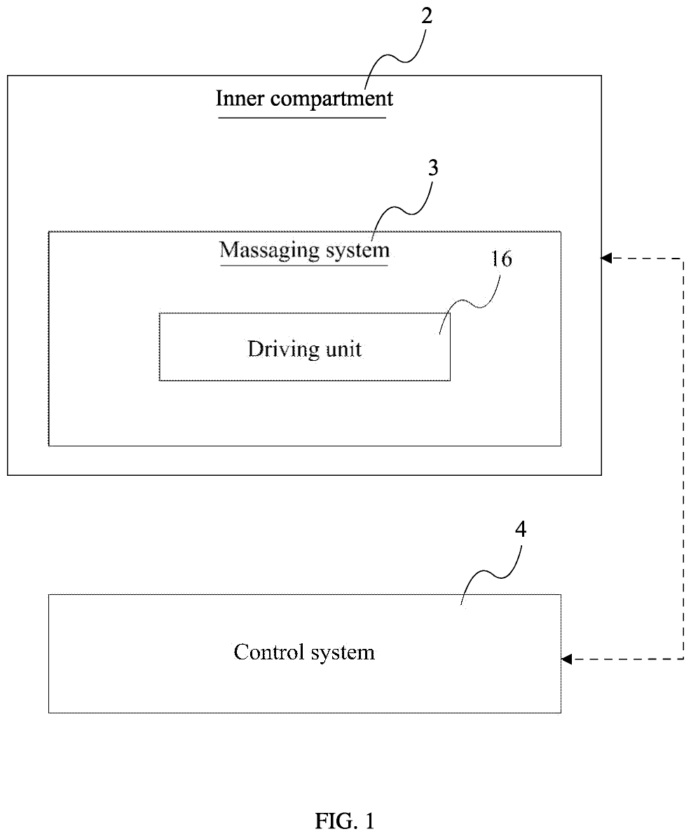

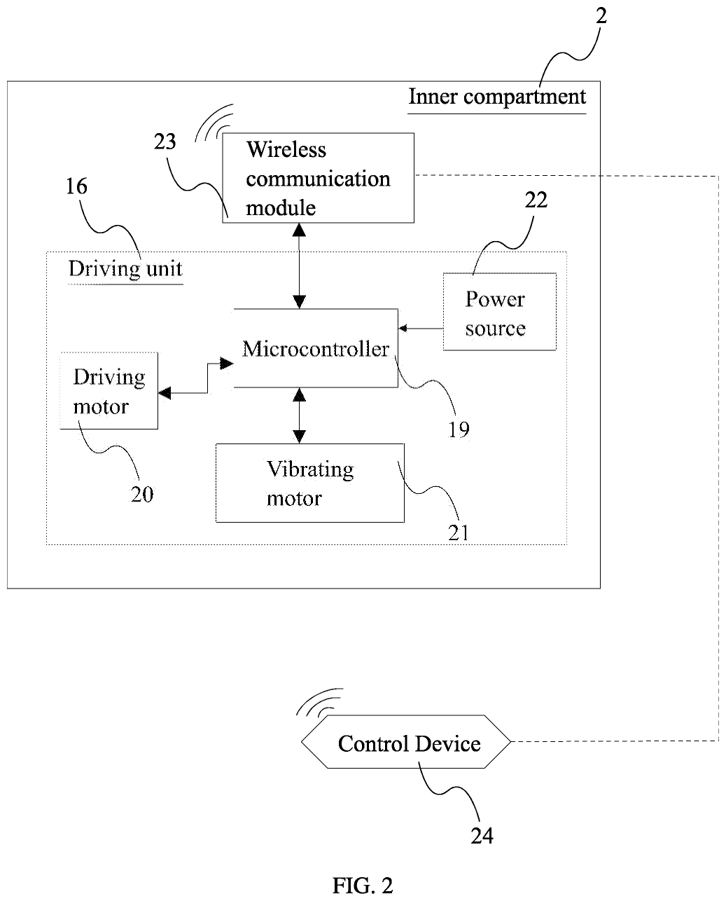

In reference to FIG. 1 through FIG. 5, the present invention is a back massaging device. An objective of the present design is to provide the user with a vest that comprises massaging units inbuilt within the vest. More specifically, it is an aim of the present invention to provide a massaging device with massaging arms that travel from the shoulders to the lower back of the user. The vest allows for a portable massaging device for users on the go or want to do other activities while having the comfort of a massage. The massaging arms in particular traverse a track that allow full coverage of the user's back. Further, the massaging device may be wirelessly controlled with a remote control or a wireless communication device.

The following description is in reference to FIG. 1 through FIG. 5. According to a preferred embodiment, the present invention comprises a vest 1, an inner compartment 2, a massaging system 3, and a control system 4. Preferably, the vest 1 comprises a front section 5, a rear section 6, and a plurality of straps 7, wherein the front section 5 is laterally offset from the rear section 6. Further, the plurality of straps 7 is terminally connected between the front section 5 and the rear section 6. More specifically, the plurality of straps 7 attaches to a top end of each the front section 5 and the rear section 6. Furthermore, the present invention comprises a neck opening 8, and a plurality of arm openings 9. The neck opening 8 traverses into the vest 1 and extends from a first end 10 of the vest 1 through a second end 11 of the vest 1, wherein the first end 10 is positioned opposite to the second end 11 across the vest. The plurality of arm openings 9 laterally traverses into the vest 1, such that the neck opening 8, and the plurality of arm openings 9 delineate the plurality of straps 7. This allows the user to put on the vest 1 by introducing their head into the neck opening 8 defined by the plurality of straps 7 wherein the plurality of straps 7 rest on the shoulders of the user. However, the present invention may be provided with any number of straps that allow the user to wear and secure the vest 1 to the torso of the user. It is preferred that the vest 1 is made of skin friendly fabric and is comfortable for the user to wear. However, the vest 1 may comprise any other material, size, components, arrangement of components etc. that are known to one of ordinary skill in the art, as long as the objectives of the present invention are fulfilled.

In the preferred embodiment, the inner compartment 2 is positioned within the rear section 6, and the massaging system 3 is mounted within the inner compartment 2. This is so that when a user is wearing the vest 1, and the massaging system 3 is being operated, the user may get a massage on the user's back. Further, the massaging system 3 is operably coupled with the control system 4, such that operating the control system 4 governs movement of the massaging system 3. In other words, a user operating the control system 4 may control the movement, the path, the pressure level etc. of the massaging system 3 with the help of the control system 3.

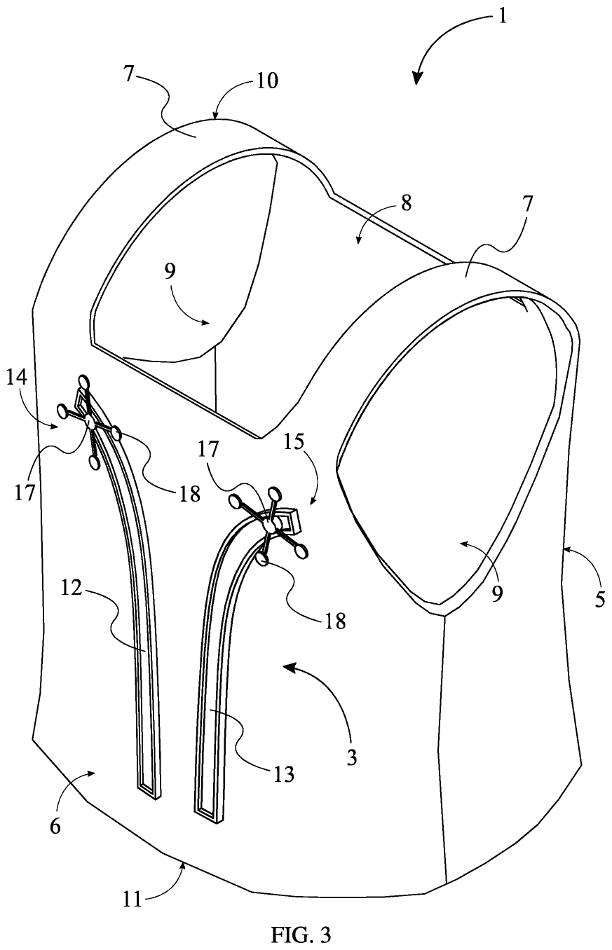

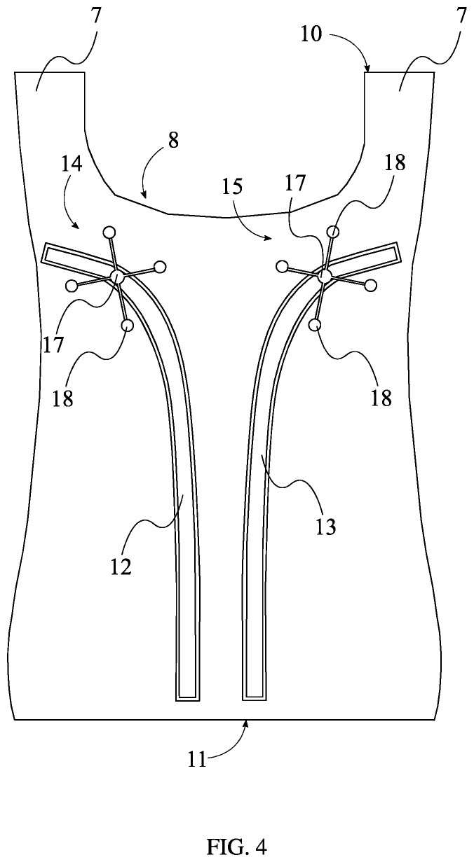

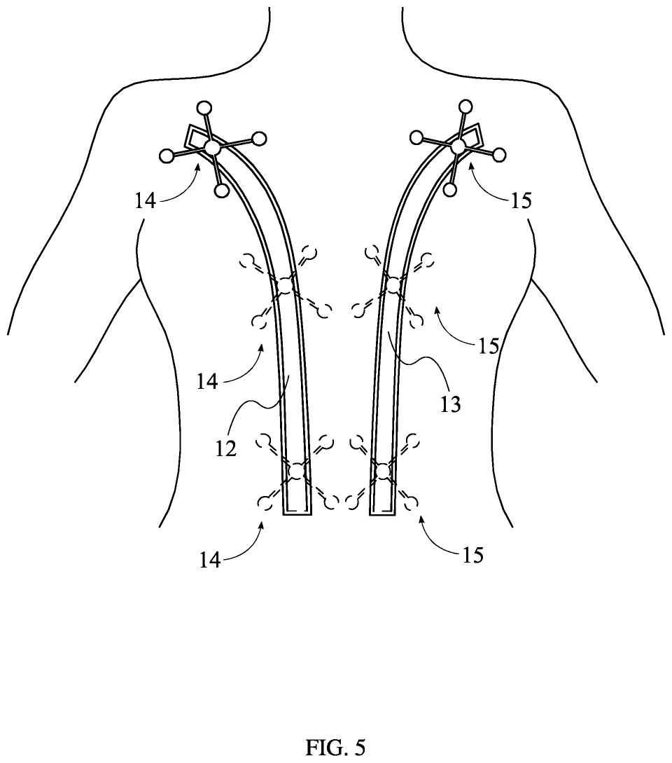

As seen in FIG. 3 through FIG. 5, the massaging system 3 comprises a first track 12, a second track 13, a first massaging unit 14, a second massaging unit 15, and a driving unit 16. In the preferred embodiment, the first track 12 and the second track 13 are mounted within the inner compartment 2 and the first track 12 is laterally offset from the second track 13. Preferably, the first track 12 and the second track 13 comprise an inverted J-shaped members. The first track 12 is positioned in the interior compartment on a left side of the rear section 6. More specifically, the hook portion of the J-shaped first track 12 is oriented towards a top left corner of the rear section 6, and the hook portion of the J-shaped second track 13 is oriented towards a top right corner of the rear section 6. Further, the first track 12 is configured to traverse from the left shoulder to the left lower back of the user and the second track 13 is configured to traverse from the right shoulder to the right lower back of the user. However, the first track 12 and the second track 13 may comprise any other shape, orientation, components, arrangement of components etc. as long as the intents of the present invention are not altered. As seen in FIG. 4 and FIG. 5, the first massaging unit 14 is engaged with the first track 12, and the second massaging unit 15 is engaged with the second track 13. This is so that the first massaging unit 14 massages the region along the first track 12 and the second massaging unit 15 massages the region along the second track 13. To enable linear and rotatory motion of the first massaging unit 14 and the second massaging unit 15, the driving unit 16 is connected with the first massaging unit 14 and the second massaging unit 15. To that end, the first massaging unit 14 is pivotally engaged with the first track 12, and the second massaging unit 15 is pivotally engaged with the second track 13. Furthermore, the first massaging unit 14 is traversable along the first track 12, and the second massaging unit 15 is traversable along the second track 13.

It is an aim of the present invention to enable a user to control the operation of the back massager according to the user's preference. To accomplish this, the control system 3 is operatively coupled with the first massaging unit 14 and the second massaging unit 15, such that operating the control system 3 governs movement of the first massaging unit 14 along the first track 12, and movement of the second massaging unit 15 along the second track 13. Preferably, the control system 3 is a wirelessly controllable remote-control system that is easy to use with easily accessible controls. However, the control system 3 may comprise any device and technology that are known to one of ordinary skill in the art, as long as the intents of the present invention are not altered.

According to the preferred embodiment of the present invention, each of the first massaging unit 14 and the second massaging unit 15 comprises a main body 17 and a plurality of arms 18. As seen in FIG. 4 and FIG. 5, the main body 17 may be a circular piece onto which the plurality of arms 18 may attach to. More specifically, a first, a second, a third, and a fourth arm radially protrude from the main body 17 to create an X-shaped configuration, or in other words the plurality of arms 18 radially extends from the main body 17. This allows the first massaging unit 14 and the second massaging unit 15 to cover more area along the back of the user.

In order to provide back massage to different points along the back of the user, the main body 17 is engaged with a corresponding track, wherein the corresponding track is from the first track 12 and the second track 13. As seen in FIG. 1, and in order to enable effective massaging with the first massaging unit 14 and the second massaging unit 15, the driving unit 16 is mounted within the main body 17. The driving unit 16 is the driving force that enables motion of the first massaging unit 14 and the second massaging unit 15. Further, the plurality of arms 18 is electronically connected to the driving unit 16, such that the driving unit 16 may move the plurality to arms 18 around the back of the user for a soothing and effective massage.

In order to provide the necessary massaging motion by the massaging units, the driving unit 16 comprises a microcontroller 19, a driving motor 20, a vibrating motor 21, and a power source 22. Preferably, the driving motor 20 and the vibrating motor 21 are electronically coupled to the microcontroller 19, and the microcontroller 19 is electrically coupled to the power source 22. The microcontroller 19 is a processing device that interprets commands received from any remote computing device and uses these commands to manage the operation of the electrical components within the present invention. Further, the driving motor 20 allows the first massaging unit 14 and the second massaging unit 15 to traverse their respective track. The vibrating motor 21 allows for therapeutic massaging vibrations along the back of the user. Furthermore, the power source 22 electrically powers the components of the present invention through the microcontroller 19. Preferably, the power source 22 is a rechargeable battery. However, the power source 22 may comprise any other components, arrangement of components, and technology that are known to one of ordinary skill in the art, as long as the intents of the present invention are not altered. It should also be noted that the microcontroller 19, the driving motor 20, the vibrating motor 21 and the power source 22 may comprise any brand, size, shape, components, technology etc. that are known to one of ordinary skill in the art, as long as the intents of the present invention are not altered.

Continuing with the preferred embodiment of the present invention, the control system 3 comprises a control device 23 and a wireless communication module 24. Preferably, the wireless communication module 24 is mounted within the inner compartment 2 and the wireless communication module 24 is electronically coupled to the microcontroller 19. The wireless communication module 24 is a wireless radio that connects and communicates with external devices via wireless data transmission protocols. The wireless communication module 24 is capable of using standards including, but not limited to, such as Bluetooth, WI-FI, GSM, CDMA, and ZigBee. Accordingly, the wireless communication module 24 is communicably coupled to the control device 23. In other words, the wireless communication module 24 allows for the retrieval and processing of a signal from the control device 23 that controls the movement of the driving motor 20. Preferably, the control device 23 is a remote-control device that may comprise a plurality of buttons that wirelessly signal the first massaging unit 14 and the second massaging unit 15 to perform certain functions. More specifically, the control device 23 may adjust the speed and pressure applied by each of the first massaging unit 14 and the second massaging unit 15. However, the control device 23 may have any control functions to control the first massaging unit 14 and the second massaging unit 15. Alternately, the control device 23 may be a smart mobile device such as an application in a smart mobile phone, or any other smart device.

In reference to FIG. 5, as the first massaging unit 14 and the second massaging unit 15 traverse their respective track, the first massaging unit 14 and the second massaging unit 15 may stroke the upper, middle, and lower back of the user.

Although the invention has been explained in relation to its preferred embodiment, it is to be understood that many other possible modifications and variations can be made without departing from the spirit and scope of the invention as hereinafter claimed.

What is claimed is:

1. A back massaging device comprising:
a vest;
an inner compartment;
a massaging system;
a control system;
the vest comprising a front section, a rear section, and a plurality of straps;
the front section being laterally offset from the rear section;
the plurality of straps being terminally connected between the front section and the rear section;
the inner compartment being positioned within the rear section;
the massaging system being mounted within the inner compartment; and
the massaging system being operably coupled with the control system, such that operating the control system governs movement of the massaging system.

2. The massaging device of claim 1, comprising:
a neck opening;
a plurality of arm openings;
the neck opening traversing into the vest and extending from a first end of the vest through a second end of the vest, wherein the first end is positioned opposite to the second end across the vest;
the plurality of arm openings laterally traversing into the vest; and
the neck opening and the plurality of arm openings delineating the plurality of straps.

3. The massaging device of claim 1, the massaging system comprising:
a first track;
a second track;
a first massaging unit;
a second massaging unit;
a driving unit;
the first track and the second track being mounted within the inner compartment;
the first track being laterally offset from the second track;
the first massaging unit being engaged with the first track;
the second massaging unit being engaged with the second track; and
the driving unit being integrated with the first massaging unit and the second massaging unit.

4. The massaging device of claim 3, comprising:
the first massaging unit being pivotally engaged with the first track;
the second massaging unit being pivotally engaged with the second track.

5. The massaging device of claim 3, comprising:
the first massaging unit being traversable along the first track;
the second massaging unit being traversable along the second track.

6. The massaging device of claim 3, wherein the control system being operatively coupled with the first massaging unit and the second massaging unit, such that operating the control system governs movement of the first massaging unit along the first track, and movement of the second massaging unit along the second track.

7. The massaging device of claim 3, wherein each of the first massaging unit and the second massaging unit comprising:
a main body;
a plurality of arms;
the plurality of arms radially extending from the main body;
the main body being engaged with a corresponding track, wherein the corresponding track is from the first track and the second track;
the driving unit being mounted within the main body; and
the plurality of arms being electronically connected to the driving unit.

8. The massaging device of claim 3, the driving unit comprising:
a microcontroller;
a driving motor;
a vibrating motor;
a power source;
the driving motor, and the vibrating motor being electronically coupled to the microcontroller; and
the microcontroller being electrically coupled to the power source.

9. The massaging device of claim 3, wherein the first track and the second track comprising an inverted J shape.

10. The massaging device of claim 1, the control system comprising:
a control device and a wireless communication module;
the wireless communication module being mounted within the inner compartment;
the wireless communication module being electronically coupled to the microcontroller; and
the wireless communication module being communicably coupled to the control device.

11. The massaging device of claim 10, wherein the control device being a remote control.

12. The massaging device of claim 10, wherein the control device being a smart mobile device.

13. A back massaging device comprising:
a vest;
an inner compartment;
a massaging system;
a control system;
the massaging system comprising a first track, a second track, a first massaging unit, a second massaging unit, and a driving unit;
the vest comprising a front section, a rear section, and a plurality of straps;
the front section being laterally offset from the rear section;
the plurality of straps being terminally connected between the front section and the rear section;
the inner compartment being positioned within the rear section;
the massaging system being mounted within the inner compartment;
the first track being laterally offset from the second track;
the first massaging unit being engaged with the first track;
the second massaging unit being engaged with the second track;
the driving unit being integrated with the first massaging unit and the second massaging unit; and
the massaging system being operably coupled with the control system, such that operating the control system governs movement of the massaging system.

14. The massaging device of claim 13, comprising:
the first massaging unit being pivotally engaged with the first track;
the second massaging unit being pivotally engaged with the second track.

15. The massaging device of claim 13, comprising:
the first massaging unit being traversable along the first track;
the second massaging unit being traversable along the second track.

16. The massaging device of claim 13, wherein the control system being operatively coupled with the first massaging unit and the second massaging unit, such that operating the control system governs movement of the first massaging unit along the first track, and movement of the second massaging unit along the second track.

17. The massaging device of claim 13, wherein each of the first massaging unit and the second massaging unit comprising:
a main body;
a plurality of arms;
the plurality of arms radially extending from the main body;
the main body being engaged with a corresponding track, wherein the corresponding track is from the first track and the second track;
the driving unit being mounted within the main body; and
the plurality of arms being electronically connected to the driving unit.

18. The massaging device of claim 13, the driving unit comprising:
a microcontroller;
a driving motor;
a vibrating motor;
a power source;
the driving motor, and the vibrating motor being electronically coupled to the microcontroller; and
the microcontroller being electrically coupled to the power source.

19. The massaging device of claim 13, wherein the first track and the second track comprising an inverted J shape.

20. The massaging device of claim 13, the control system comprising:
a control device and a wireless communication module;
the wireless communication module being mounted within the inner compartment;
the wireless communication module being electronically coupled to the microcontroller; and
the wireless communication module being communicably coupled to the control device.
